(19) United States
(12) Patent Application Publication
(10) Pub. No.: US 2026/0243514 A1
(43) Pub. Date: Aug. 20, 2026

(54) OPENING SYSTEM FOR A DOOR OF A FREEZE-DRYING MACHINE

(71) Applicant: I.M.A. Industria Macchine Automatiche S.p.A., Ozzano dell'Emilia (BO) (IT)

(72) Inventors: Alex Scapoli, Ozzano dell'Emilia (BO) (IT); Michele Zavatta, Bologna (IT)

(21) Appl. No.: 18/874,528

(22) PCT Filed: May 22, 2023
(86) PCT No.: PCT/IB2023/055239

§ 371 Date: Dec. 12, 2024

(30) Foreign Application Priority Data
Jun. 20, 2022 (IT) 102022000012949

(51) Int. Cl. F26B 25/12; F26B 5/06

(52) U.S. Cl. CPC F26B 25/12; F26B 5/06

(57) ABSTRACT

An opening system (1) for a door (22) of a freeze-drying machine (101) is disclosed, this machine having a freeze-drying chamber delimited by a plurality of walls. Access to the chamber for loading and removing containers in which the product to be freeze-dried is housed takes place through a window (103) obtained in a vertical wall of the chamber. The system comprises a door (22) configured to occlude the window (103) of the freeze-drying machine (101), a transmission mechanism (2) configured to command the opening and closing of the door (22) and a support wall (3) configured to support said transmission mechanism.

The present invention relates to an opening system for a door of a freeze-drying machine.

A freeze-drying process is a process that removes a solvent or suspending medium, typically water, from a product. Pharmaceutical freeze-drying is often an aseptic process that requires sterile conditions within a freeze-drying chamber. It is critical to ensure that all components of the freeze-drying system that come into contact with the product are sterile and furthermore that the environment surrounding the freeze-drying machine is easy to clean and is not a source of possible contamination for the product entering and leaving the system.

Freeze-drying systems typically incorporate a lyophilization chamber delimited by a plurality of walls and configured to receive a plurality of containers or vials containing sterile material to be freeze-dried. Access to the chamber for loading and removing vials is through a window formed in a vertical wall of the chamber. This window is generally rectangular in shape and its opening or closing depends on the positioning of a vertically moved door to block or free access through the window. Generally, the opening system comprises a transmission mechanism having a plurality of mechanical components suitable for transmitting the motion generated by an actuator, so as to move the door automatically. The need to insert the actuator in a specific position, sheltered and often distanced from the door to be moved, introduces the need to have an articulated transmission mechanism having a considerable number of components usually exposed to the external environment of the freeze dryer, but still in an aseptic area.

Maintaining sterile conditions inside the freeze dryer requires periodic cleaning and sterilization of the door and the opening system associated with it, furthermore the area in front of the access window to the freeze dryer must also remain in an aseptic condition.

A drawback of the prior art is that the opening system is made up of a large number of components which must be arranged in proximity to the door to be operated, and since the area in front of the door must be kept in an aseptic condition, this translates in a greater time necessary for their cleaning and in a greater difficulty of this process. Furthermore, the morphology of the door opening system also makes cleaning of the system difficult.

An example of these systems is described in the patent application WO2005/088216 A1 whose opening mechanism comprises a first shaft connected to an actuator in its central portion and connected to two threaded shafts at the ends. These threaded shafts are positioned on a respective side with respect to the door and are connected to the door for its movement. As can be easily understood, cleaning the threaded shafts is difficult due to the grooves within the threads and moreover their friction with threaded gears which transmit the motion generated by an actuator can produce debris contaminating the product to be freeze-dried.

Furthermore, even if the threaded shafts are covered with elastic sleeves or “bellows”, even these are not free from drawbacks.

There is therefore a technical requirement for an improved opening system having a limited number of components exposed to the external environment and for compact implementation, so as to have an easier and faster cleaning process, as well as for an opening system which does not generate dust during its operation.

The object of the present invention is to address this requirement by providing a system for opening a door for a freeze-drying machine. The system comprises a motion transmission mechanism configured to command the opening and closing of a door and a support wall to support the transmission mechanism in accordance with claim 1.

The present invention is exposed and characterized in the independent claims. The dependent claims disclose other features of the present invention or preferred variants of the main solution.

Embodiments described herein relate to a door opening system for a freeze-drying machine, the system comprising a motion transmission mechanism and a support wall for the mechanism.

According to embodiments described herein, the motion transmission mechanism comprises a first wheel associated with said wall, a second wheel associated with a first lever and a third wheel rigidly coupled to a second lever.

According to an embodiment provided herein, the transmission mechanism comprises a primary drive shaft rotating about a rotation axis X, wherein said first wheel is coaxially mounted with said drive shaft.

According to an embodiment described herein said second lever is rotatably coupled in a second distal region thereof to said door so as to open and close the door.

According to a characteristic aspect of the present invention, the apparatus comprises a closed box in which said first, second and third wheels are housed.

According to embodiments, the closed box is configured to rotate about the rotation axis X with a rotational speed equal to the rotational speed of said primary transmission shaft.

In accordance with embodiments provided herein, the first transmission lever forms at least partially housed within said closed box.

An advantage of the opening system according to the present invention, is that cleaning operations of the mechanical components being part of the system and arranged around the access window of a freeze-drying machine are facilitated as they are enclosed inside the closed box.

Another advantage of the present invention is that it avoids the dispersion of possible particles which can detach by friction between the mechanical components of the opening system, being these particles retained inside the closed box.

A further advantage of the present invention is given by the compactness of the opening system having few moving components.

### BRIEF DESCRIPTION OF DRAWINGS.

These and other aspects, features and advantages of the present invention will become clear from the following description of embodiments, provided by way of non-limiting example, with reference to the accompanying drawings in which:

FIG. 1 is a schematic view of an opening system in accordance with the present invention applied to a freeze-drying machine;

FIG. 2 is a schematic axonometric view showing the configuration of an opening system in accordance with the present invention;

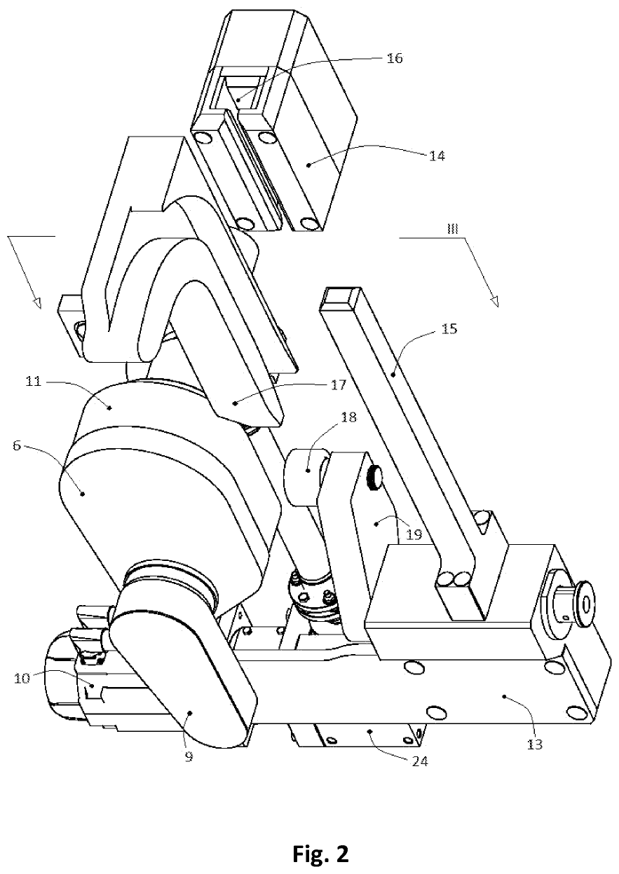

FIG. 3 is a schematic view of the opening system in a section along the plane III of FIG. 2;

FIG. 4 is a schematic axonometric view of a portion of the transmission system forming part of the opening mechanism in accordance with the present invention.

For ease of understanding, identical reference numerals have been used wherever possible to identify identical elements in the figures. It should be understood that elements and features of one embodiment can be conveniently incorporated into other embodiments without further clarification.

### DESCRIPTION OF EMBODIMENTS OF THE PRESENT INVENTION

Reference will now be made in detail to the various embodiments of the invention, one or more examples of which are illustrated in the accompanying figures. Each example is provided by way of illustration of the invention and is not intended as a limitation of the same. For example, features illustrated or described as being part of one embodiment may be adopted upon, or in association with, other embodiments to produce a further embodiment. It is understood that the present invention will include such modifications and variations. Before describing the embodiments, it is also clarified that the present description is not limited in its operation to constructional and arrangement details of the components as described in the following description using the accompanying figures. The present disclosure may include other embodiments and be made or practiced in a variety of other ways. Furthermore, it is clarified that the phraseology and terminology used herein is for descriptive purposes and should not be taken as limiting.

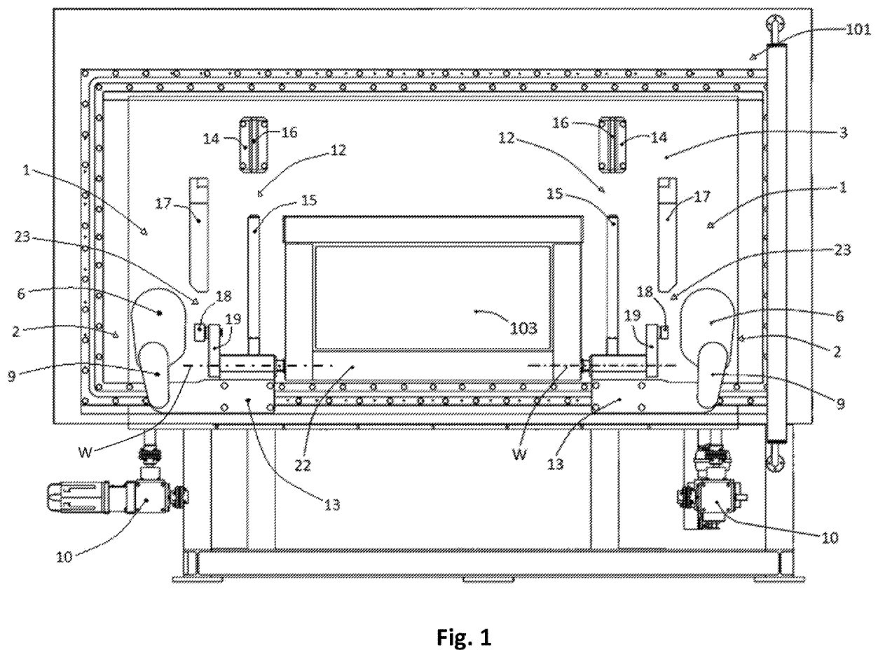

Embodiments described using the enclosed figures refer to an opening system 1 for a door 22 of a freeze-drying machine 101, of which only one wall is shown. The freeze-drying machine 101 is used to remove a solvent or suspending medium thereof from pharmaceuticals, typically such as water. The machine is equipped with a freeze-drying chamber separated from the external environment by a plurality of walls. One of these walls, the one shown in FIG. 1, is provided with an access window 103 configured to allow one or more containers or vials containing the sterile product on which the freeze-drying process will be performed to be inserted into the chamber.

The system 1 is particularly suitable for being used in the pharmaceutical field for the automatic movement of a door associated with the window of a freeze-drying chamber so as to be able to insert and extract the product to be processed.

As visible in FIG. 1, the opening system 1 comprises a door 22 configured to close an access window 103 of the freeze-drying machine 101.

The opening system 1 also comprises a motion transmission mechanism 2 configured to control the opening and closing of the door 22 automatically, as will be explained in greater detail below.

The opening system 1 also comprises a support wall 3 configured to support said transmission mechanism 2.

In one embodiment, the support wall 3 coincides with one of the walls of the plurality of walls which delimit the freeze-drying chamber of the machine.

The support wall 3 has a preferably substantially vertical arrangement, parallel to the development surface of the window 103.

The door 22 is preferably movable between two operative positions. A closed position wherein the door 22 shut the window 103 and an open position wherein the window 103 is open and the chamber is accessible.

According to embodiments, the door 22, when in the closed position, in FIG. 1 in the lowered position, has a preferably substantially vertical arrangement and parallel to the development surface of the window 103. The door 22, when commanded to open or close moving between the two operative positions, performs a sliding movement along a movement trajectory that is at least partially straight and parallel to the window 103 and to the support wall 3.

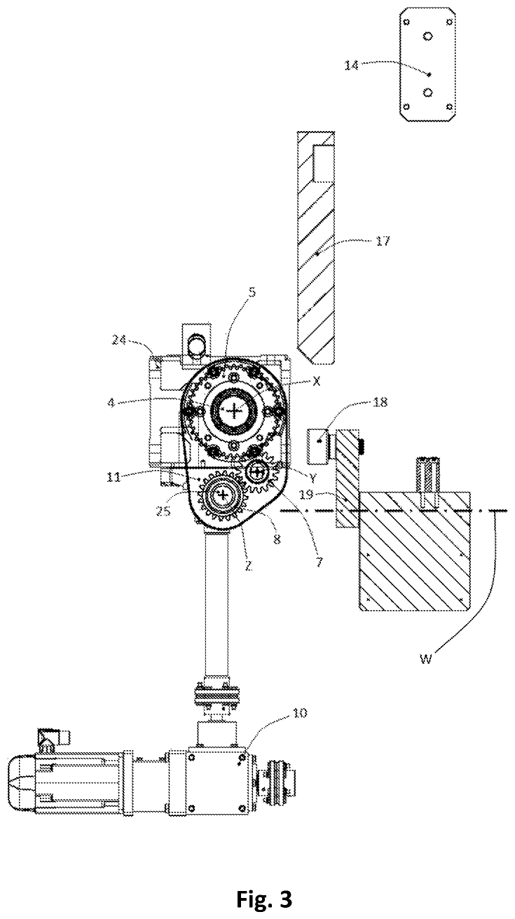

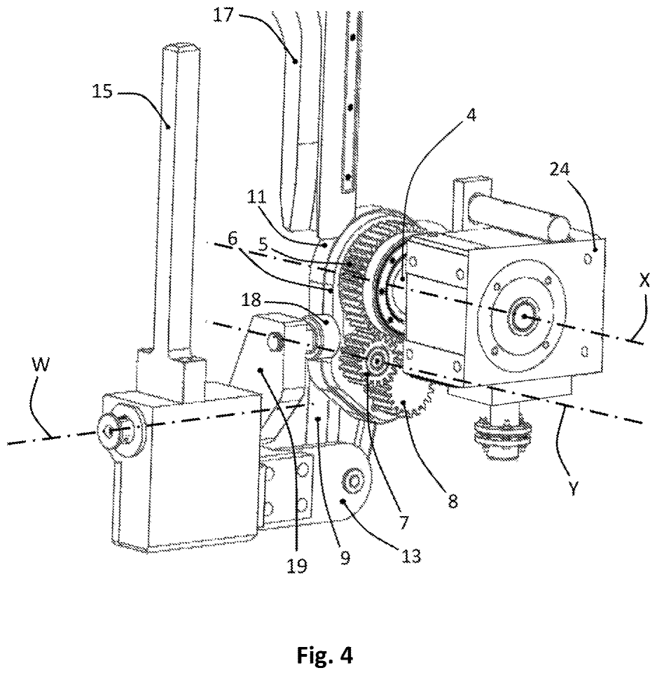

According to embodiments as visible in FIGS. 3 and 4, the transmission mechanism 2 comprises a primary drive shaft 4 rotatable about a first axis of rotation X substantially perpendicular to said support wall. The primary drive shaft 4 in its initial portion is connected to an actuator device 10 which generates the motion necessary to move the door 22.

The actuator device 10 according to preferred embodiments can be positioned on the opposite side of the support wall 3 with respect to the transmission mechanism 2, so as to have the primary drive shaft 4 that crosses the support wall 3.

According to embodiments, the primary drive shaft 4 can be connected directly to the actuator 10 or can be connected to it through a joint device 24 such as for example a cardan joint, gear wheels, belts or chains. According to embodiments, the support wall 3 comprises a through hole, crossed by said primary drive shaft 4. According to different alternative embodiments, the support wall 3 comprises a cavity configured to at least partially house said joint device 24.

The transmission mechanism 2 comprises, as visible in FIGS. 3 and 4, a first wheel 5 mounted coaxially to said primary drive shaft 4 and fixed to the support wall 3, so as not to rotate. In this way the first wheel 5 is fixed both with respect to the support wall 3 and with respect to the primary drive shaft 4, even during the rotation of the latter.

According to embodiments, the transmission mechanism 2 comprises a first transmission lever 6 rigidly coupled to said drive shaft 4 in a first proximal region of said first transmission lever 6. Through this coupling, the first transmission lever 6 is able to rotate around the first axis of rotation X jointly with the rotation of said primary drive shaft 4.

The transmission mechanism then comprises a second idle wheel 7 rotatably mounted on the first transmission lever 6, visible in FIG. 4. Said second idle wheel 7 having as its axis of rotation a second axis of rotation Y preferably parallel to the first axis of rotation X. Said second idle wheel 7 idly cooperating with said first wheel 5.

According to embodiments, the transmission mechanism 2 comprises a third wheel 8, cooperating with said second idle wheel 7 and rotatably coupled to the first transmission lever 6 in a first distal region of the latter. In practice, the second idle wheel 7 can rotate with respect to the first transmission lever 6. According to embodiments, the transmission mechanism 2 comprises a second transmission lever 9 mounted so as to be rigidly coupled in a second proximal region thereof to the third wheel 8. In practice, when the third wheel 8 rotates, the second lever 9 also rotates. Preferably the third wheel 8 is rigidly coupled to the second lever 9 via a transmission pin 25, this in turn mounted so as to be coaxial to the third wheel 8. In this way the second lever 9 jointly rotates with the rotation of the third wheel 8 according to a common third axis of rotation Z, parallel to said first axis of rotation X.

The rotation of the primary drive shaft 4 therefore sets the first transmission lever 6 in rotation, which in turn drives the second idle wheel 7, causing it to rotate on the first wheel 5 which is fixed. In practice, the second idle wheel 7 rotates with the direction of rotation opposite to the direction of rotation of the primary drive shaft 4. In this manner the third wheel 8, cooperating with said second idle wheel 7, is set in rotary motion with axis of rotation Z and direction of rotation accordingly to that of the primary drive shaft 4.

In this way the second transmission lever 9 rotates together with the rotation of the third wheel 8.

According to embodiments, said second transmission lever 9 is coupled in its second distal region to the door 22, so as to move it in opening and closing according to the rotation of said primary drive shaft 4.

The opening system described here is characterized in that the first 5, second 7 and third 8 wheel are housed inside a closed box 11.

The closed box 11 is configured as a plurality of walls which delimit a closed internal space wherein the indicated mechanical elements are contained.

Said closed box 11 being arranged to contain at least the three wheels described above and is configured to be conveniently opened by an operator for purposes of maintenance or to check the mechanical parts contained therein. It is clear that said box 11 can be implemented as a plurality of shells mounted around the mechanical parts to be contained.

Preferably, the closure of this box 11 is of hermetic type.

According to alternative embodiments, said closed box 11 is configured to rotate when the primary drive shaft 4 is rotating. More specifically, the closed box 11 is configured to rotate about the axis of rotation X with a rotation speed equal to the rotation speed of said primary drive shaft 4. It is evident that according to this embodiment the closed box 11 is rigidly coupled to the first transmission lever 6.

According to alternative embodiments the first transmission lever 6 is at least partially housed within said closed box 11. In this embodiment one or more shells will be coupled to the first transmission lever 6 jointly constituting the box 11 in which the three wheels 5, 7, 8 are contained.

According to further embodiments the transmission mechanism 2 is connected to the door 22 through a guide unit 12 visible in FIG. 1. Said guide unit 12 comprising a plurality of elements suitable for allowing the movement of the door 22. The guide unit 12 has the main function of allowing the movement of the door 22 in opening and closing according to one pre-established direction.

Said guide unit 12 comprises a bracket 13 coupled to the second distal region of said second lever 9 and further coupled to said door 22. The coupling between said bracket 13 and at least one between the second lever 9 and said door 22 is preferably of the rotatable type, allowing the rotation of said second lever 9 with respect to the door 22. In this way the rotary motion of the second lever 9 can be translated into a translational motion needed for the opening and closing of the door 22. Said translational motion being at least partially a sliding motion parallel to the support wall 3.

The guide unit 12 can further comprise a guide body 14 fixed to said support wall 3 and a sliding rod 15 fixed to said door 22, said sliding rod 15 being configured to slide inside a sliding channel 16 obtained in said guide body 14. The sliding rod 15 being preferably rigidly fixed to the door 22 through said bracket 13. Conveniently said sliding rod 15 and said sliding channel 16 have a parallel development with respect to said support wall 3.

According to a predefined embodiment said system 1 further comprises a tilting unit 23 comprising an arcuate sliding body 17 attached to said wall 3 and a sliding roller 18 fixed to said door 22. Said sliding roller 18 is configured to slide on said arcuate sliding body 17 thus moving an upper end of the door 22 away from the support wall 3 exposing a rear surface of said door 22, i.e. the part of the door which fits inside the freeze dryer chamber. The sliding roller 18 being preferably coupled to the door 22 via a sliding lever 19.

The sliding lever 19 is in turn rotatable about a rotation axis W perpendicular to the first rotation axis X.

This embodiment therefore allows the door 22 to be tilted when it is opened with respect to the window 103, allowing the rear part of the door to be cleaned.

According to alternative embodiments, the first 5, the second 7 and the third wheel 8 are configured as toothed wheels which respectively cooperate according to the methods indicated above. Alternatively, the three wheels (5,7,8) can be configured as toothed wheels or pulleys which cooperate together through the motion of predefined sliding means such as chains or belts respectively.

As previously stated, the opening system 1 according to embodiments can further comprise the actuator 10 connected to said motion transmission mechanism 2 and configured to generate the motion transmitted by the transmission mechanism 2 to command the opening and closing of said door 22. Preferably the motion generated by the actuator 10 is of the rotary type with the rotation axis coinciding or parallel to the first rotation axis X of the primary drive shaft 4.

It therefore appears clear how the opening system 1 described herein according to various embodiments can be used on the freeze-drying machine 101, this machine comprising, as mentioned above, a chamber having at least one wall, the chamber being accessible through a window 103 formed on said wall by opening a door 22, said opening being carried out by means of the opening system 1 according to the present invention. It is clear that according to this embodiment the wall of the chamber of the freeze-drying machine coincides with or is integral with the support wall 3 of the opening system.

The opening system 1 object of the present invention can comprise a single transmission mechanism 2 for opening the door 22 or can conveniently comprise two transmission mechanisms 2 similar to each other for an easier opening of the door 22. Preferably the door 22 has a rectangular shape and in the configuration shown above, each transmission mechanisms 2 is respectively positioned on the left and on the right side of the door 22 as visible in FIG. 1.

As can be appreciated from what has been described, the opening system for a door of a freeze-drying machine according to the present invention makes it possible to satisfy the requirements and overcome the drawbacks mentioned in the introductory part of the present description with reference to the prior art.

Obviously, a person skilled in the art may make numerous modifications and variations to the invention described above, in order to satisfy contingent and specific needs, all of these modifications however contained within the scope of protection of the invention as defined by the following claims.

1. An opening system (1) for a door of a freeze-drying machine (101), said system (1) comprising:
a door (22) configured to close an access window (103} of a freeze-drying machine (101};
a motion transmission mechanism (2) configured to control opening and closing of said door (22);
a support wall (3) configured to support said transmission mechanism (2);
10 said transmission mechanism (2) comprising:
a primary drive shaft (4) rotating around a first axis of rotation (X) substantially perpendicular to said support wall (3), characterised in that said transmission mechanism (2) further comprising:
a first wheel (5) coaxially mounted to said primary drive shaft (4) and
1s fixed to said support wall (3) so as not to rotate,
a first transmission lever (6) rigidly coupled to said primary drive shaft
(4) in a first proximal area so as to rotate about said first axis of rotation (X),
a second idle wheel (7) idly cooperating with said first wheel (5) and
20 rotatable mounted around a second axis of rotation (Y) on said first transmission lever (6), a third wheel (8) cooperating with said second idle wheel (7) and rotatably coupled to said first transmission lever (6) at a first distal region thereof,
wherein said first (5), second (7) and third wheels (8) are housed within a closed box (11}.

2. The system as in claim 1, wherein said closed box (11) is configured to rotate about said first axis of rotation (X) with a rotational speed equal to the rotational speed of said drive shaft.

3. The system as in claim 1, wherein said first transmission lever (6) is also at least partially housed within said closed box (11).

4. They system as in claim 1, wherein said second axis of rotation (Y) is parallel to said first axis of rotation (X).

5. The system as in claim 1, wherein said second lever (9) is rotatably coupled to said door (22) by means of a bracket (13), said bracket (13) being rigidly attached to an edge of said door (22).

6. System as in claim 1, wherein the coupling between said bracket (13) and at least one between the second lever (9) and said door (22) is rotatable, allowing rotation of said second lever (9) with respect to the door (22) and translating the rotary motion of the second lever (9) into translational motion in opening and closing of the door (22), said translational motion being at least partially a sliding motion parallel to the support wall (3).

7. The system as in claim 1, wherein the third wheel (8) rotates in the same direction of the primary drive shaft (4).

8. The system as in claim 1, comprising a guide unit (12) comprising a guide body (14) attached to said support wall and a sliding rod (15) attached to said door (22), said sliding rod (15) being configured to slide within a sliding channel (16) formed in said guide body (14).

9. The system as in claim 1, further comprising a tilting unit (23) comprising an arcuate sliding body (17) attached to said wall (3) and a sliding roller (18) coupled to said door (22), said sliding roller (18) being configured to slide on said arcuate sliding body (17} while the door (22) moves in the opening configuration so as to tilt the door (22} making a rear surface of said door (22) accessible.

10. The system as in claim 1, wherein said first (5), second (7) and third wheels (8) are gear wheels meshing with each other.

11. The system as in claim 1, further comprising an actuator device (10) connected to said transmission mechanism (2) and configured to rotate said primary drive shaft

12. The system as in claim 1, wherein the support wall (3) comprises a through hole, crossed by said primary drive shaft (4).

13. The system as in claim 1, comprising two transmission mechanisms (2) each positioned on a side of said door (22) with the door (22) therebetween.

14. The system as in claim 1, wherein said closed box (11) is hermetically closed.

15. A freeze-drying machine (101) comprising an enclosed chamber provided with an access window (103) closed by an opening system (1) according to claim 1.
